(19) United States
(12) Patent Application Publication
(10) Pub. No.: US 2005/0073497 A1
(43) Pub. Date: Apr. 7, 2005

(54) Remote control device capable of sensing motion

(76) Inventor: Taek Sung Kim, Syosset, NY (US)

Correspondence Address: Samuel Lee, P.O. Box 927959, San Diego, CA, 92192-7959, US

(21) Appl. No.: 10/661,732

(22) Filed: Sep. 12, 2003

(51) Int. Cl. G09G 5/08

(52) U.S. Cl. 345/158; 455/352

(57) ABSTRACT

A remote control device includes a processor and at least first and second sensors, which are operatively configured to provide position information of at least first and second points, respectively, on the remote control device. The provided position information is sufficiently accurate to distinguish the first point from the second point, such that the provided position information of the first point with respect to the position information of the second point provides enough information to the processor to determine yaw, pitch, horizontal and vertical translation motions of the remote control device with respect to a terrestrial plane.

### BACKGROUND

The present disclosure generally relates to remote control devices, and more specifically, to remote control devices capable of sensing motion.

Remote control devices are widely used for controlling the operation of electronic devices, such as household electronic appliances, from a location remote from the electronic devices. Examples of electronic devices may include television, video camera recorder (VCR), and audio equipment, such as a CD player and/or a stereo system. Such remote control devices often transmit operational signals by wireless radio transmission, for example, an infrared signal.

The conventional remote control device controls such functions of the electronic devices as ON/OFF state, channel selection, volume control, play, fast-forward, rewind, and other functions. The remote control device provides convenience of effectuating these functions without having to physically move to the electronic device every time it is desired to change the state of the function. Therefore, the remote control device allows the user to remotely change or select the state of the device function.

However, functions and devices that may be controlled by such a conventional remote control device are often limited in terms of complexity and use. Integration of electronic devices (e.g., television and audio equipment) with computers and computing devices increases the need for a remote control device that can select item(s) on a display or screen that is interfacing with the integrated electronic device/computer system by sensing the motion of the control device.

A mouse or mouse-like device is typically used with a computer display. However, the mouse device is also limited in that it needs a flat surface to operate, and is often limited by the need for a wire connection to the computer.

Remote control devices with a joystick on top are known. However, these conventional devices are limiting because they can select only a limited number of pre-defined items on the screen. Furthermore, since the joystick on the remote control device is designed to be controlled by a thumb or finger, sensitivity and accuracy of item selection can be significantly degraded.

In terms of reducing repetitive motion injury (e.g., carpal tunnel syndrome), it is well known that using forearm to make motions for item selections on the screen causes less injury than using wrist or finger. Thus, to alleviate the repetitive motion injury problem, attempts have been made to use gyroscopes in the remote control device to sense the movement of forearm. However, gyroscopes can be cumbersome to use, bulky, and expensive.

Accordingly, there is a need for an enhanced remote control device that can sense motion but without the above-described limitations of the conventional remote control devices.

### SUMMARY

A remote control device includes a processor and at least first and second sensors, which are operatively configured to provide position information of at least first and second points, respectively, on the remote control device. The provided position information is sufficiently accurate to distinguish the first point from the second point, such that the provided position information of the first point with respect to the position information of the second point provides enough information to the processor to determine yaw, pitch, horizontal and vertical translation motions of the remote control device with respect to a terrestrial plane.

In one aspect, the sensors are configured with a pair of antennas and a differential GPS receiver. The processor includes a motion converter that converts the position information of the first and second points into the yaw, pitch, horizontal and vertical translation motions of the remote control device with respect to the terrestrial plane. The processor also includes a cursor movement converter that converts the processed yaw, pitch, horizontal and vertical translation motions into a cursor movement on a screen.

In another aspect, a method for controlling a graphical icon on a screen using a remote control device is described. The method includes determining position information of at least two points on the remote control device sufficiently accurate to distinguish the two points. The position information is resolved into yaw, pitch, horizontal and vertical translation motions, and the resolved motions are then converted into movement information of the graphical icon.

### BRIEF DESCRIPTION OF THE DRAWINGS

Different aspects of the disclosure will be described in reference to the accompanying drawings.

FIG. 1A shows a perspective view of a remote control device performing a yaw motion.

FIG. 1B illustrates the horizontal movement of a cursor on a computer screen in response to the yaw motion of the remote control device.

FIG. 2A shows a perspective view of a remote control device performing a horizontal translation motion.

FIG. 2B illustrates the horizontal movement of a cursor on a computer screen in response to the horizontal translation motion of the remote control device.

FIG. 3A shows a perspective view of a remote control device performing a pitch motion.

FIG. 3B illustrates the vertical movement of a cursor on a computer screen in response to the pitch motion of the remote control device.

FIG. 3C shows a side view of the remote control device illustrating the pitch motion.

FIG. 4A shows a perspective view of a remote control device performing a vertical translation motion.

FIG. 4B illustrates the vertical movement of a cursor on a computer screen in response to the vertical translation motion.

FIG. 4C shows a side view of the remote control device illustrating the vertical translation motion.

FIG. 5 shows a front view of an exemplary remote control device according to an embodiment of the present invention.

FIG. 6 is a block diagram of a remote control device according to an embodiment of the present invention.

FIG. 7 illustrates a configuration of position sensors as a pair of antennas and a differential GPS in accordance with an embodiment of the present invention.

### DETAILED DESCRIPTION

To meet the need for an enhanced remote control device that can sense motion but without the limitations of the conventional remote control devices, exemplary embodiments are described for a remote control device that can sense four degrees of freedom motions, which include a yaw motion, a pitch motion, a horizontal translation motion, and a vertical translation motion. The yaw and horizontal translation motions cause the cursor to move horizontally on the screen, while the pitch and vertical translation motions cause the cursor to move vertically.

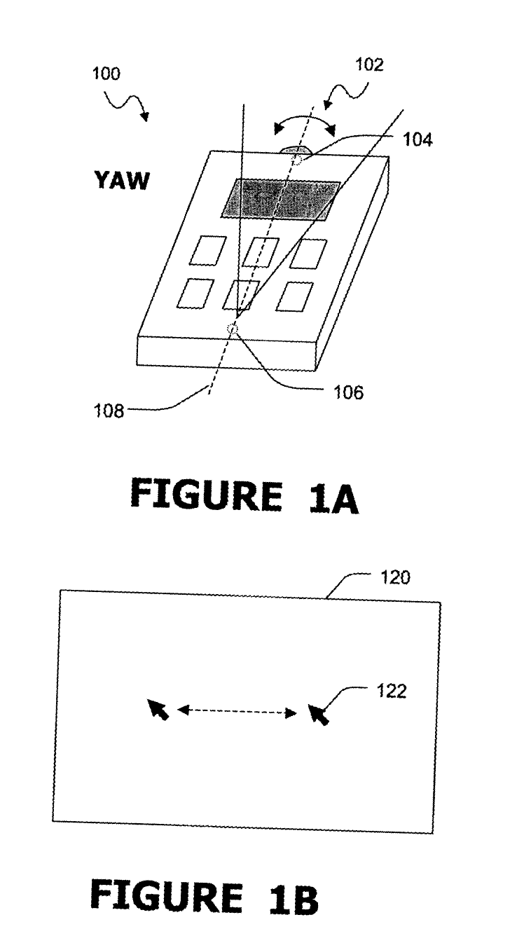

FIG. 1A shows a perspective view of a remote control device 100 in accordance with an embodiment of the present invention. In the illustrated embodiment of FIG. 1A, the remote control device 100 is shown in a configuration in which the device makes a “yaw” movement 102. The “yaw” movement 102 is defined in this specification as a horizontal angular movement of a point 104 on the remote control device 100 with respect to another point 106 on the remote control device. The horizontal plane on which the angular movement is measured is defined as a terrestrial horizontal plane. For typical remote control purposes, the terrestrial horizontal plane is substantially parallel with “horizon” or a flat surface on earth. Thus, the yaw movement 102 will move a cursor 122 horizontally on the screen 120 (that is placed “level” on a flat surface) as shown in FIG. 1B. The amount or distance of the cursor movement depends on the angle of the yaw movement 102.

To be compatible with the conventional definition of “yaw” used for aircraft motion, the point 104 should be in front of the point 106 with respect to the perspective of the user, who is present behind the point 106. Thus, a line from the point 106 to the point 104 will typically be pointing toward the screen 120. However, the direction will be reversed in an unusual situation when the user's back is facing the screen 120.

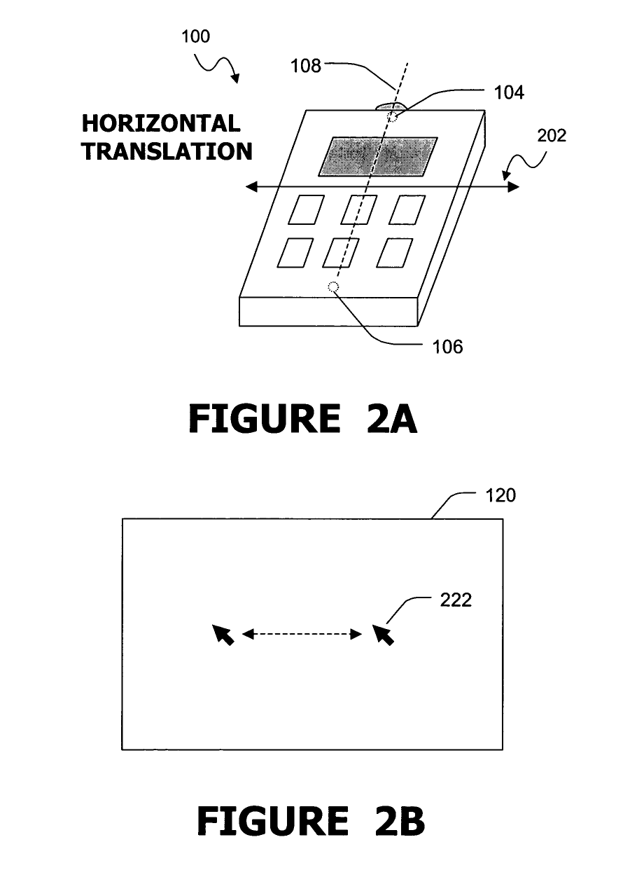

FIG. 2A shows another configuration in which the remote control device 100 makes a horizontal translation movement 202. The horizontal translation movement 202 is defined in this specification as a horizontal movement of a line 108 connecting the point 104 with the point 106 with respect to the terrestrial horizontal plane. Thus, the horizontal translation movement 202 will move a cursor 222 horizontally on the screen 120 as shown in FIG. 2B. The amount or distance of the cursor movement depends on the distance or length of the translation movement 202.

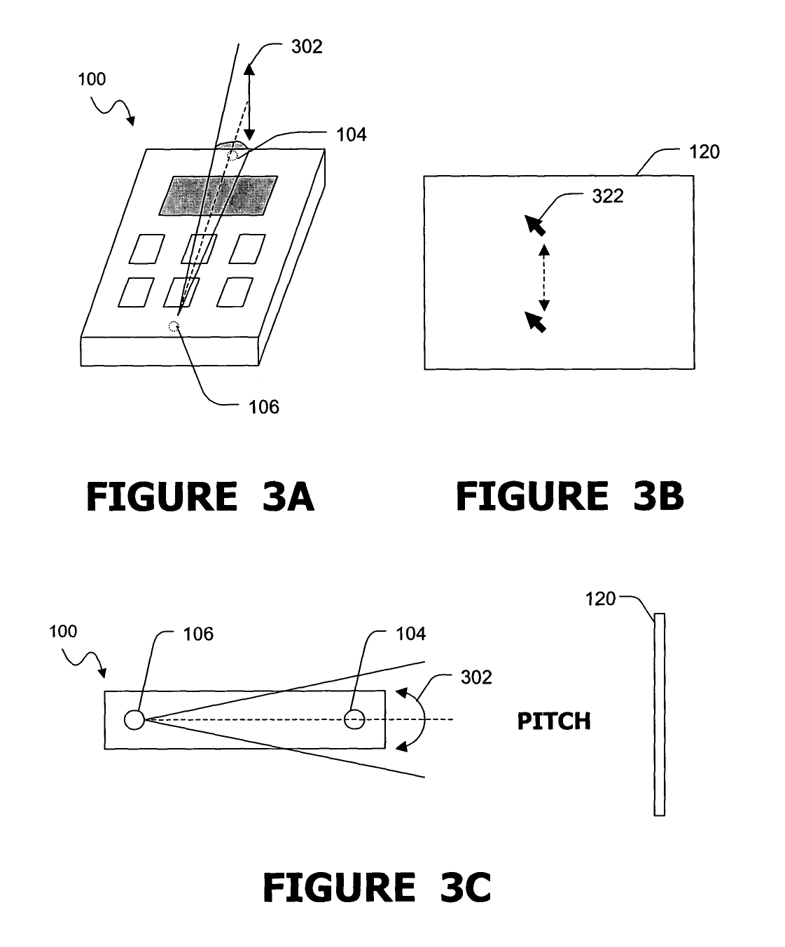

FIG. 3A shows another configuration of the remote control device 100 in which the device makes a “pitch” movement 302. The “pitch” movement 302 is defined in this specification as a vertical angular movement of the point 104 with respect to the point 106 on the remote control device. Again, the vertical angular movement is measured with respect to the terrestrial horizontal plane. Thus, the pitch movement 302 will move a cursor 322 vertically on the screen 120 as shown in FIG. 3B.

FIG. 3C shows a side view of the remote control device 100 illustrating the pitch movement 302. The amount or distance of the vertical cursor movement depends on the angle of the pitch movement 302.

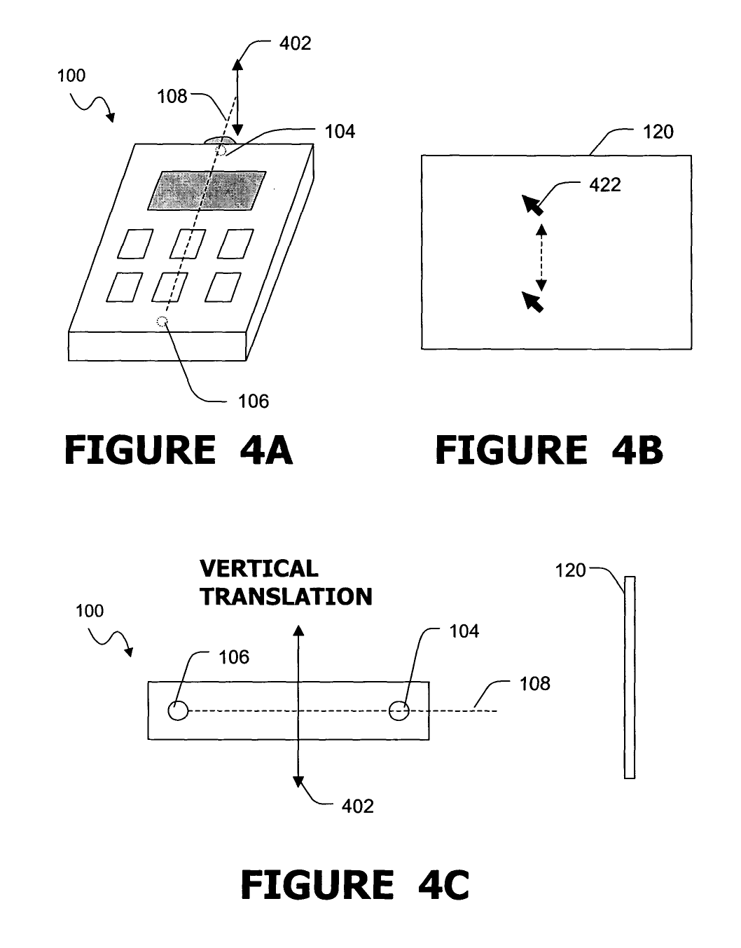

FIG. 4A shows another configuration in which the remote control device 100 makes a vertical translation movement 402. The vertical translation movement 202 is defined in this specification as a vertical movement of the line 108 connecting the point 104 with the point 106. The vertical movement is defined as a movement along a plane that is perpendicular to the terrestrial horizontal plane. Thus, the vertical translation movement 402 will move a cursor 422 vertically on the screen 120 as shown in FIG. 4B. The amount or distance of the cursor movement depends on the distance or length of the vertical translation movement 402. FIG. 4C shows a side view of the remote control device 100 illustrating the vertical translation movement 402.

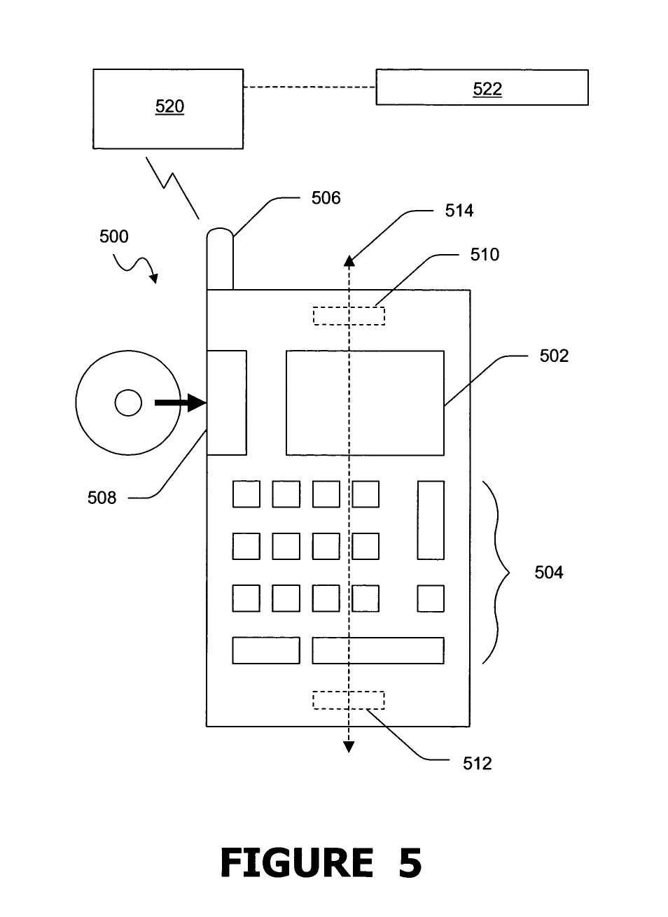

FIG. 5 shows a front view of an exemplary remote control device 500 according to an embodiment of the present invention. FIG. 5 also illustrates a block diagram of an external device 520 and a screen 522 that interfaces with the external device. In one embodiment, the external device 520 is a computer. In another embodiment, the external device is a television. The remote control device 500 is used to control a graphical icon or cursor on the screen 522. The remote control device 500 can be used to control displays for electronic devices other than a computer or television.

In the illustrated embodiment of FIG. 5, the remote control device 500 includes a local display 502 and various function keys and buttons 504. The remote control device 500 also includes an antenna 506, which is used to transmit or receive radio frequency signals to and from the external device 520. The remote control device 500 may also include a CD or disk drive 508. In illustrated embodiment, the drive 508 is a CD ROM drive.

The exemplary remote control device 500 also includes a pair of position sensors 510, 512, which are operatively configured so that the sensors 510, 512 can sense the motions (i.e., yaw, pitch, horizontal translation, and vertical translation motions) of an imaginary line 514, as described above. The motions of the line 514 are measured with respect to the terrestrial horizontal plane. Thus, various motions of the remote control device 500 are visually fed back to a user by the graphical icon or cursor displayed on the screen 522. Movement of a cursor on the screen 522 copies the motions of the remote control device 500. Thus, yaw, pitch, horizontal translation, and vertical translation motions are combined and processed to produce a resultant movement of the cursor on the screen 522, which is level positioned on a flat surface of the earth. If the screen 522 is positioned at an angle rather than level on a flat surface, then this information should be entered into the remote control device 500 to account for the tilt and appropriately offset the movement of the cursor. The processor 502 can appropriately calculate the offset of the cursor movement.

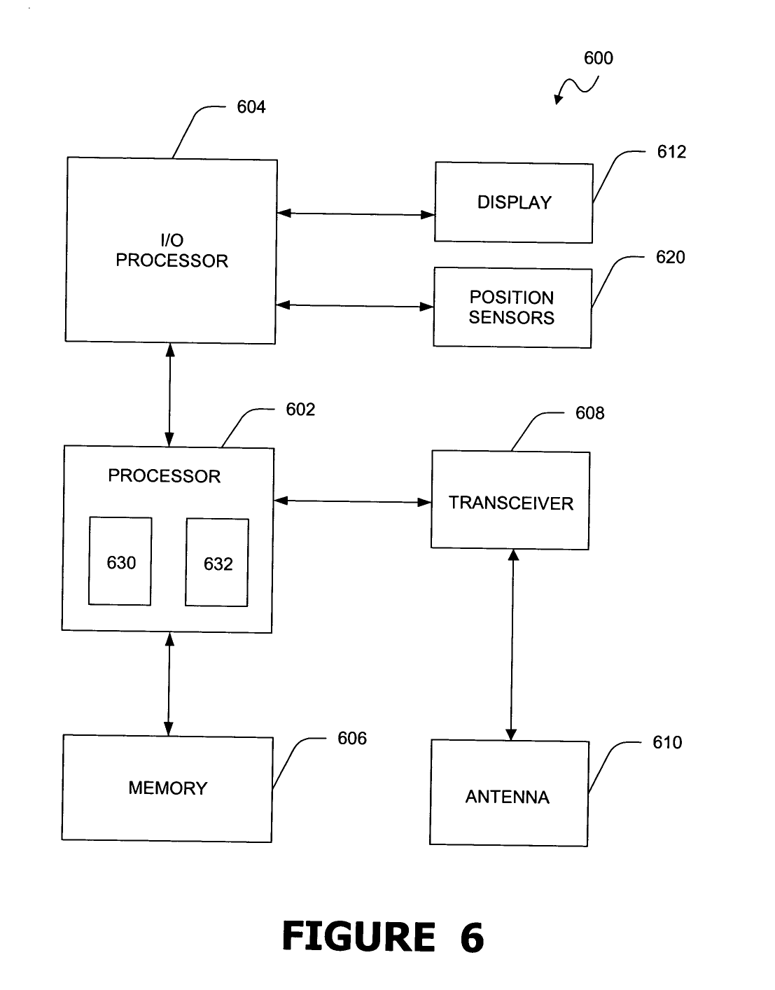

A block diagram of a remote control device 600 according to an embodiment of the present invention is shown in FIG. 6. The remote control device 600 comprises a main processor 602 and at least first and second sensors 620. The sensors 620 are operatively configured to provide position information of at least first and second positions, such as 104 and 106 on the remote control device 100 in FIG. 1A through FIG. 4A. The position information provided by the sensors 620 should be sufficiently accurate to distinguish the first position (e.g., position 104) from the second position (e.g., position 106), such that the provided position information of the first position with respect to the second position provides enough information to the processor 602 to determine yaw, pitch, horizontal and vertical translation motions of the remote control device.

In the illustrated embodiment of FIG. 6, the main processor 602 interfaces with an I/O processor 604 and a memory 606. The I/O processor 604 processes and controls a local display 612 and the sensors 620. The local display 612 can be used to display local information such as estimated motions of the remote control device with respect to the terrestrial plane and the resultant cursor movement. The display 612 can also show information such as cursor offset, position information of the remote control device, and other related information.

The main processor 602 receives the position information of the first and second positions. The main processor 602 includes a motion converter 630 that processes the position information to determine angle and distance of the yaw, pitch, horizontal and vertical translation motions. The processor 602 also includes a cursor movement converter 632 which converts these motions into an amount of cursor movement on the main screen. The main processor 602 interfaces with external devices (e.g., a computer 520 shown in FIG. 5) through a transceiver 608 and an antenna 610. Thus, the amount of cursor movement is transmitted to an external device through the transceiver 608. The transceiver 608 also receives commands and messages from the external device. In some embodiments, the main processor 602 and the I/O processor 604 may be configured as one processor performing both functions.

In the illustrated embodiment of FIG. 6, the sensors 620 are configured as position sensors rather than as attitude sensors, such as a gyroscope, for sensing the motions of the remote control device 600 because position sensors are cheaper and easier to maintain than the attitude sensors. However, the use of position sensors 620 requires the sensors to be sufficiently accurate so that the movement of at least two points on the remote control device with respect to the terrestrial horizontal plane can be ascertained.

For example, a typical conventional remote control device that controls electronic devices, such as a television, may be about 15 to 20 centimeters long and about 4 to 6 centimeters wide. If the dimensions of the remote control device 500 shown in FIG. 5 is assumed to be approximately similar to the conventional remote control device, and it is assumed that the sensors would be placed longitudinally at the ends of the remote control device 500, then the accuracy of the sensors 620 should be within about 5 to 7 centimeters in order to sufficiently accurately determine the movement of the line between the two points with respect to the terrestrial horizontal plane.

With the advent of Global Positioning System (GPS), terrestrial navigation has been made possible with position accuracy in the range of about one to two meters. This still is not sufficient to distinguish the positions of points within a remote control device, whose dimensions are as described above. The main source of errors that contribute to degradation of GPS accuracy to this range is the timing errors. Accordingly, if the timing errors can be sufficiently corrected, the position accuracy of the GPS measurement would improve significantly. A concept referred to as “differential GPS” has been used to improve the GPS accuracy by significantly reducing the timing errors. Accordingly, it was realized that the use of a differential GPS receiver with antennas strategically placed on the remote control device can provide terrestrial positions with sufficient accuracy (i.e., within about 5 to 7 centimeters) to enable motion sensing within the remote control device.

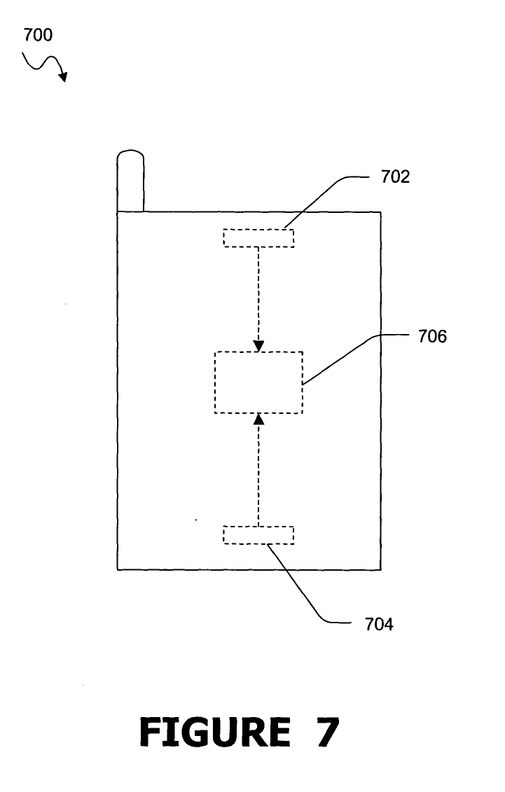

FIG. 7 illustrates a configuration of position sensors as a pair of antennas and a differential GPS in accordance with an embodiment of the present invention. Various function keys and buttons have been omitted for clarity.

In the illustrated embodiment of FIG. 7, the remote control device 700 includes sensors, which are configured as a pair of antennas 702, 704 and a differential GPS receiver 706. The antenna 702 provides received GPS signal at a position where the antenna 702 is located. Likewise, the antenna 704 provides received GPS signal at a position where the antenna 704 is located. The differential GPS receiver 706 receives the signals from the two antennas 702, 704, along with corrections necessary to substantially reduce the timing errors. In an alternative embodiment, the sensors can be configured as a plurality of antennas and a corresponding plurality of differential GPS receivers.

In one embodiment, the corrections can be received from a source through a transceiver on the remote control device. The source may be an Internet site that provides the corrections when the approximate location of the remote control device is entered. In another embodiment, the corrections can be locally broadcast to the transceiver. In a further embodiment, the corrections can be calculated by the differential GPS receiver 706 by providing sufficiently accurate position information of the relatively stationary remote control device 700.

While specific embodiments of the invention have been illustrated and described, other embodiments and variations are possible. Although the position sensors have been presented as being configured as a differential GPS receiver with two antennas, other position sensors, available now or in the future, that can provide similar position accuracy of the points on the remote control device are contemplated. For example, the position sensors can be relative sensors that constantly measure the 3-dimensional position of the remote control device with respect to a fixed position such as a top corner of a main display.

All these are intended to be encompassed by the following claims.

1. A remote control device, comprising:
a processor; and
at least first and second sensors operatively configured to provide position information of at least first and second points, respectively, on the remote control device, the position information being sufficiently accurate to distinguish the first point from the second point, such that the provided position information of the first point with respect to the position information of the second point provides enough information to the processor to determine yaw, pitch, horizontal and vertical translation motions of the remote control device with respect to a terrestrial plane.

2. The remote control device of claim 1, wherein said at least first and second sensors include first and second antennas, and a differential GPS receiver.

3. The remote control device of claim 2, wherein the first antenna operating with the differential GPS receiver provides the position information of the first point to the processor.

4. The remote control device of claim 2, wherein the second antenna operating with the differential GPS receiver provides the position information of the second point to the processor.

5. The remote control device of claim 1, wherein the processor includes a motion converter that converts the position information of the first and second points into the yaw, pitch, horizontal and vertical translation motions of the remote control device with respect to the terrestrial plane.

6. The remote control device of claim 1, wherein the processor includes a cursor movement converter that converts the processed yaw, pitch, horizontal and vertical translation motions into a cursor movement on a screen.

7. The remote control device of claim 6, further comprising:
a transceiver configured to transmit the processed cursor movement to an external device and to receive commands or messages from the external device.

8. The remote control device of claim 7, wherein the external device is a computer.

9. The remote control device of claim 7, wherein the external device is a television.

10. The remote control device of claim 6, wherein said at least first and second sensors include relative sensors that measure position information of the remote control device with respect to a fixed position on the screen

11. The remote control device of claim 1, further comprising:
a local display configured to display local information.

12. The remote control device of claim 11, wherein the local information includes a cursor movement offset.

13. A remote control device, comprising:
at least first and second antennas; and
at least one global positioning system (GPS) receiver including a processor, said at least one GPS receiver coupled to said at least first and second antennas, said at least one GPS receiver configured to operate in a differential mode so that position information of the first and second antennas is provided sufficiently accurate to distinguish position of the first antenna from position of the second antenna,
wherein said at least first and second antennas are configured such that the provided position information of the first antenna with respect to the second antenna provides enough information for the processor to determine yaw, pitch, horizontal and vertical translation motions of the remote control device with respect to a terrestrial plane.

14. The remote control device of claim 13, wherein the processor includes a motion converter that converts the position information of the first and second antennas into the yaw, pitch, horizontal and vertical translation motions of the remote control device with respect to the terrestrial plane.

15. The remote control device of claim 13, wherein the processor includes a cursor movement converter that converts the processed yaw, pitch, horizontal and vertical translation motions into a cursor movement on a screen.

16. The remote control device of claim 15, further comprising:
a transceiver configured to transmit the processed cursor movement to an external device and to receive commands or messages from the external device.

17. The remote control device of claim 13, further comprising:
a local display configured to display local information.

18. The remote control device of claim 17, wherein the local information includes estimated motions of the remote control device.

19. A method for controlling a graphical icon on a screen using a remote control device, comprising:
determining position information of at least two points on the remote control device sufficiently accurate to distinguish the two points;
resolving the position information into yaw, pitch, horizontal and vertical translation motions; and
converting the yaw, pitch, horizontal and vertical translation motions into movement information of the graphical icon.

20. The method of claim 19, further comprising:
transmitting the movement information to the screen to appropriately move the graphical icon.
